(19) United States
(12) Patent Application Publication
(10) Pub. No.: US 2017/0251178 A1
(43) Pub. Date: Aug. 31, 2017

(54) IMAGING APPARATUS

(71) Applicant: CANON KABUSHIKI KAISHA, Tokyo (JP)

(72) Inventor: Tomohiro Kawamoto, Tokyo (JP)

(21) Appl. No.: 15/439,818

(22) Filed: Feb. 22, 2017

(30) Foreign Application Priority Data
Feb. 25, 2016 (JP) 2016-034829

(51) Int. Cl. H04N 7/18; G06K 9/00; B66B 5/00; G01C 5/06

(52) U.S. Cl. CPC H04N 7/183; G01C 5/06; G06K 9/00362; B66B 5/0018; B66B 5/0012

(57) ABSTRACT

An imaging apparatus includes a barometric pressure detection unit configured to detect barometric pressure inside a movable body, a storage unit configured to store a table in which a height of a position of the movable body is associated with barometric pressure, an update unit configured to update the table with a detection result obtained by the barometric pressure detection unit, and a determination unit configured to determine whether the movable body stops, wherein the update unit updates the table in a case where the determination unit determines that the movable body stops.

### BACKGROUND

Field of the Disclosure

The present disclosure relates to an imaging apparatus, particularly relates to an imaging apparatus to be installed in the inside of an elevator.

Description of the Related Art

There has been an increasing number of cases where an imaging apparatus such as a monitoring camera is installed in the inside of an elevator for security reasons. In such a case, it is beneficial for an observer to specify a floor where a monitoring target person has gotten on or off in addition to a video image of the monitoring camera.

Traditionally, some monitoring cameras are used in combination with control apparatuses that control elevators because a floor on which the elevator stops cannot be specified only with video images of the monitoring cameras installed inside the elevators. For example, Japanese Patent Application Laid-Open No. 2002-234676 discusses a technique for specifying a number of the floor where a monitoring target person has gotten on or off by connecting a monitoring camera installed inside an elevator to an elevator control apparatus.

### SUMMARY

The present disclosure is directed to a monitoring camera capable of specifying a floor that an elevator stops on, without an operation to connect to an elevator control apparatus.

According to an aspect of the present disclosure, an imaging apparatus that captures an interior image of a movable body includes a barometric pressure detection unit configured to detect barometric pressure inside the movable body, a storage unit configured to store a table in which a height of a position of the movable body is associated with barometric pressure, an update unit configured to update the table with a detection result obtained by the barometric pressure detection unit, and a determination unit configured to determine whether the movable body stops, wherein the update unit updates the table in a case where the determination unit determines that the movable body stops.

Further features of the present disclosure will become apparent from the following description of exemplary embodiments with reference to the attached drawings.

### BRIEF DESCRIPTION OF THE DRAWINGS

FIG. 1A is a diagram illustrating a configuration of an imaging apparatus, and FIG. 1B is a diagram illustrating a network configuration including the imaging apparatus according to one or more aspects of the present disclosure.

FIG. 2 is a diagram illustrating an internal configuration of the imaging apparatus according to one or more aspects of the present disclosure.

FIG. 3 is a diagram illustrating a table stored in a memory according to one or more aspects of the present disclosure.

FIG. 4 is a diagram schematically illustrating a table setting operation according to one or more aspects of the present disclosure.

FIG. 5 is a flowchart illustrating processing executed by a control unit according to one or more aspects of the present disclosure.

FIG. 6 is a diagram illustrating a table stored in a memory according to one or more aspects of the present disclosure.

FIG. 7 is a flowchart illustrating processing executed by the control unit according to one or more aspects of the present disclosure.

FIG. 8 is a diagram illustrating processing for updating a table by detecting opening and closing of a door from a video image according to one or more aspects of the present disclosure.

FIG. 9 is a diagram illustrating network communication according to one or more aspects of the present disclosure.

### DESCRIPTION OF THE EMBODIMENTS

Hereinafter, an exemplary embodiment of the present disclosure will be described in detail with reference to the appending drawings.

Configurations in the below-described exemplary embodiments are merely examples, and the present disclosure is not limited to the below-described configurations.

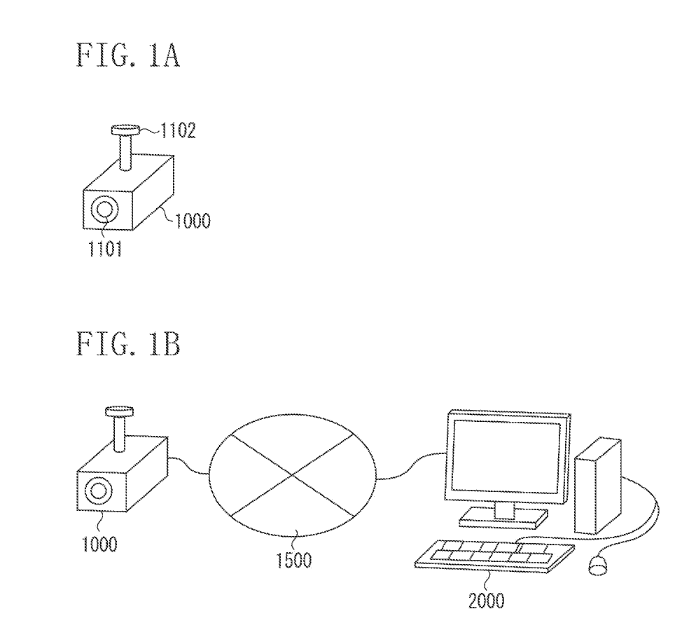

A first exemplary embodiment of the present disclosure will be described below. Hereinafter, a network configuration according to the present exemplary embodiment will be described with reference to FIGS. 1A and 1B.

FIG. 1A is a diagram illustrating an imaging apparatus 1000 as one exemplary embodiment of the present disclosure. A housing 1101 includes a lens. The imaging apparatus 1000 is suspended from a ceiling with an arm mechanism 1102 which can determine an orientation of the imaging apparatus 1000 in the pan and tilt directions according to an installation site and an imaging angle at the time of installation.

FIG. 1B is a diagram illustrating a system configuration including the imaging apparatus 1000. A client apparatus 2000 corresponds to an external apparatus in the present disclosure. The imaging apparatus 1000 and the client apparatus 2000 are communicably connected to each other via an internet protocol (IP) network 1500. The client apparatus 2000 transmits to the imaging apparatus 1000 various commands including commands for changing imaging parameters (described below) or commands for starting video image streaming. The imaging apparatus 1000 transmits a response or a streaming video image corresponding to the commands to the client apparatus 2000.

The imaging apparatus 1000 in the present exemplary embodiment is an example of an image processing apparatus which communicates with an external apparatus via a network. Examples of such an image processing apparatus include a monitoring camera that captures a moving image. More specifically, the imaging apparatus 1000 is a network camera used for monitoring.

The IP network 1500 includes a plurality of routers, switches, and cables which satisfy a communication standard such as Ethernet (registered trademark). In the present exemplary embodiment, a communication standard, a scale, and a configuration of the IP network 1500 are not particularly limited as long as the imaging apparatus 1000 and the client apparatus 2000 can communicate with each other.

For example, the IP network 1500 may be configured of the internet, a wired local area network (LAN), a wireless LAN, or a wide area network (WAN). Further, the IP network 1500 may be a network provided with a cloud. In addition the imaging apparatus 1000 in the present exemplary embodiment may support Power over Ethernet (PoE) (registered trademark) system, and the power may be supplied via a LAN cable.

The client apparatus 2000 in the present exemplary embodiment is an example of an external apparatus, such as a personal computer (PC) and a smartphone. The client apparatus 2000 includes internal components, such as a display unit for displaying a user interface (UI) (not illustrated), an input unit, e.g., a keyboard and a touch panel, and a storage unit for storing an image obtained from the imaging apparatus 1000. The monitoring system in the present exemplary embodiment corresponds to an imaging system.

In the present exemplary embodiment of the present disclosure, a description is given taking as an example a case where the imaging apparatus 1000 is installed in the inside of an elevator (movable body) of a five-story building.

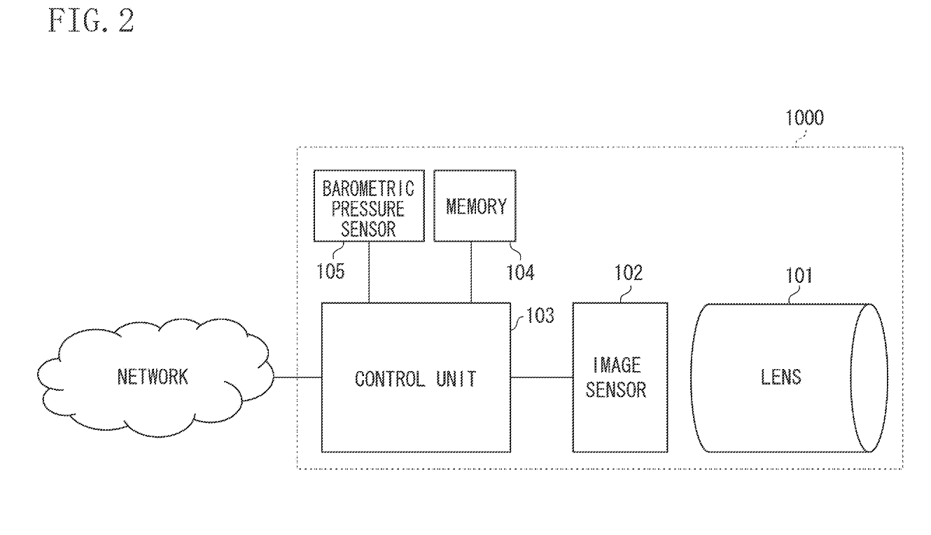

A configuration of the imaging apparatus 1000 according to the present exemplary embodiment will be described with reference to FIG. 2. A light beam from an imaging object enters an image sensor 102 via a lens 101, and an image is formed thereon as an object image. Then, the image sensor 102 images and outputs the object image as a video image signal. A control unit 103 controls the lens 101 so as to, for example, change an aperture, adjust a focal position to focus on the object, and inserting or removing an infrared cut filter. The image sensor 102 includes an analog-to-digital (AD) conversion unit (not illustrated) and a predetermined image correction unit (not illustrated). The video image signals of the captured video image is appropriately processed and input to the control unit 103.

The control unit 103 includes a central processing unit (CPU), and entirely controls respective components of the imaging apparatus 1000 and sets various parameters. A memory 104 includes a memory from which data can be deleted electrically, and the control unit 103 executes a program stored in this memory. The memory 104 is used as a storage region for a program to be executed by the control unit 103, a work area for executing a program, and a storage region for data. The memory 104 stores an image captured by the imaging apparatus 1000 and a table in which data about barometric pressure as an output result of a barometric pressure sensor (described below) is stored in association with floor information regarding the elevator.

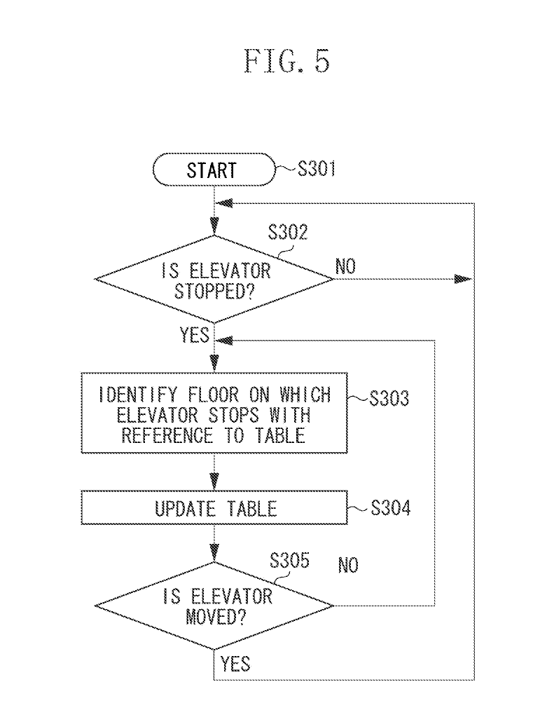

A barometric pressure sensor 105 obtains barometric pressure inside the elevator in which the imaging apparatus 1000 is installed. According to vertical movement of the elevator, the barometric pressure sensor 105 outputs data about measured barometric pressure to the control unit 103 as a measurement result. The control unit 103 refers to the measurement result received from the barometric pressure sensor 105 and a table stored in the memory 104 in which barometric pressure is associated with floor information, and determines a floor number on which the elevator currently stops. Details of the reference processing will be described in detail below with reference to FIG. 5. The barometric pressure sensor 105 according to the present exemplary embodiment corresponds to a barometric detection unit.

The control unit 103 includes a communication unit, and receives control commands, from the client apparatus 2000, including setting commands, such as instructions for various settings with respect to the image, instructions for exposure control with respect to the object image, and instructions relating to coding. The setting command with respect to the image is analyzed by the control unit 103. At the same time, image setting information is stored in the memory 104, and the control unit 103 sets respective components according to the image setting information stored in the memory 104, at the time of activation. Further, the control unit 103 distributes video image data to the network 1500 connected thereto. In the present exemplary embodiment, the control unit 103 corresponds to a distribution unit that distributes captured video image data about the interior image of the movable body.

The control unit 103 further includes a coding unit and executes compression coding according to coding setting information included in a setting command with respect to coding received by the communication unit. For example, the coding setting information includes specification information about a coding method, an image size, rotation of an image, and resolution of an image. The coding setting information includes information about an instruction to superimpose, for example, characters on an image. In addition, processing for superimposing, for example, characters on the image can be executed by a superimposing unit included in the control unit 103.

The control unit 103 includes a detection unit. The control unit 103 executes processing with respect to the video image, such as detection of a person and/or an object, while obtaining the video image signals from the image sensor 102.

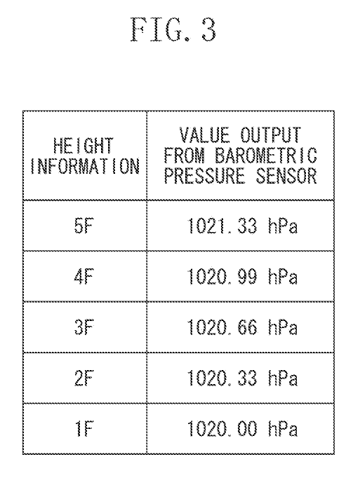

FIG. 3 illustrates an example of data in a table in which values of barometric pressure and height information are stored in the memory 104 in association with each other. The height information (i.e., floor number, such as “1F” or “2F”) and values output from the barometric pressure sensor are stored in the memory 104 in association with each other. Instead of the floor numbers, the height information may be a height (i.e., meter), or may be indicated with a plurality of floors collectively.

More specifically, the barometric pressure of the first floor is associated with a value of 1020.00 hPa. The barometric pressure of the second floor is associated with a value of 1020.33 hPa. The barometric pressure of the third floor is associated with a value of 1020.66 hPa. The barometric pressure of the fourth floor is associated with a value of 1020.99 hPa. The barometric pressure of the fifth floor is associated with a value of 1021.33 hPa.

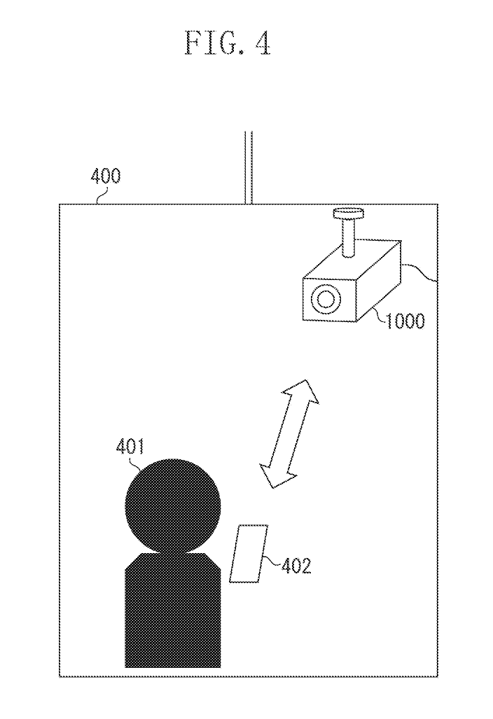

It is desirable that an installation contractor create this table as initial setting values when the imaging apparatus 1000 is installed in an elevator. The initial setting operation will be described with reference to FIG. 4. The imaging apparatus 1000 is installed in an elevator 400. An installation contractor 401 who installs the imaging apparatus 1000 operates a setting device 402 to set initial setting values such as a view angle and account information. Examples of the setting device 402 include a mobile device, such as a tablet terminal and a smartphone. The imaging apparatus 1000 and the setting device 402 are connected to each other via the communication unit included in the control unit 103 through the wired connection, such as a universal serial bus (USB) cable and a coaxial cable, or the wireless connection, such as a wireless LAN and Bluetooth (registered trademark). The setting device 402 may include a barometric pressure sensor. In the present exemplary embodiment, the communication unit included in the control unit 103 corresponds to a receiving unit that receives information about external barometric pressure via a network.

The installation contractor 401 inputs information about a floor number on which the elevator 400 currently stops to the imaging apparatus 1000 as a setting value via the setting device 402. After the floor information is input, the control unit 103 obtains current barometric pressure from the barometric pressure sensor 105. Then, the control unit 103 sets the obtained barometric pressure to the table in the memory 104 together with the floor information input via the setting device 402. Performing of the process on every floor can obtain a table having values for all of the floors. In addition, barometric pressure values of floors other than the barometric pressure value input by the setting device 402 may be obtained by adding a uniform value (e.g., 0.33 hPa) instead of actually measuring the respective values, or the barometric pressure values may be obtained by calculating an intermediate value by measuring barometric pressure values of two floors or more. Through the above methods, time taken for the installation can be reduced. Further, in the present exemplary embodiment, although the floor information is input from the setting device 402, the present exemplary embodiment is not limited thereto. For example, the barometric pressure sensor may be installed in a specific floor (e.g., first floor), and the table stored in the memory 104 may be created and updated based on values obtained by the barometric pressure.

Further, a value output from barometric pressure sensor may include a predetermined barometric pressure range, and thus a barometric pressure value of a space between floors may be regarded as a barometric pressure value of an upper floor or a lower floor. More specifically, a value between the barometric pressure values 1020.00 hPa and 1020.33 hPa of the first and the second floors, respectively, may be regarded as the barometric pressure value of the first floor. In a case where the table is not created by the installation contractor, a user can manually create the table by measuring the barometric pressure after stopping the elevator at each floor using the client apparatus 2000. In such a case, it is desirable for the user to obtain floor information about a floor on which the elevator currently stops, with a user interface of the client apparatus 2000.

Further, since the barometric pressure fluctuates continuously, the table has to be appropriately updated (corrected). A process for correcting the table will be described with reference to the flowchart illustrated in FIG. 5. The control unit 103 executes the processing in the flowchart.

In step S301, the control unit 103 starts correction processing. Then, the processing proceeds to step S302.

In step S302, the control unit 103 determines whether an elevator in which the imaging apparatus 1000 is installed is stopped. If the control unit 103 determines that the elevator is stopped (YES in step S302), the processing proceeds to step S303. In the present exemplary embodiment, the control unit 103 determines whether the elevator is stopped based on whether an amount of change is equal to or less than a predetermined value. More specifically, the control unit samples output values of the barometric pressure sensor 105 for a plurality of times at predetermined intervals. The control unit 103 then obtains an amount of change in barometric pressure in the sampled values. The control unit 103 determines whether the elevator stops by comparing the obtained amount of change with a threshold value stored in the memory 104. As described above, the control unit 103 makes such a determination using a fact that fluctuation in barometric pressure caused by a change in weather conditions is very moderate in comparison to fluctuation in barometric pressure with the movement of the elevator. For example, if the amount of change per one second is equal to or less than 0.33 hPa, the control unit 103 determines that the elevator is stopped. A threshold value used for the judgement may be changed as appropriate. For example, the threshold value may be changed according to a type of the barometric pressure sensor, the number of floors, a season, a time, or the weather. Further, in the present exemplary embodiment, although the control unit 103 determines the state movement state that the elevator stops, the present exemplary embodiment is not limited thereto. For example, the control unit 103 may determine a movement state of the elevator, e.g., a case where the elevator is moved to a specific floor.

If the control unit 103 determines that the elevator is stopped, in step S303, the control unit compares a value output from the barometric pressure sensor 105 with a value of the table stored in the memory 104 and judges a number of the floor on which the elevator currently stops. Then, the processing proceeds to step S304. If a value output from the barometric pressure sensor 105 is 1020.03 hPa, the control unit 103 judges that the elevator currently stops on the first floor based on the fact that 1020.03 hPa is the closest to the corresponding value of the barometric pressure sensor for the first floor from among the values stored in the table. After making the determination, the control unit 103 associates the video image with the floor number on which the elevator currently stops, i.e., distributing a video image on which an image indicating “1F” as a determination result is superimposed, and storing the determination result in metadata together with the specified time. Further, in the present exemplary embodiment, the control unit 103 corresponds to a data control unit that associates judged floor information as a determination result with video image data and a judgement unit that judges a height of the movable body based on the detection result obtained by the barometric pressure detection unit and the table.

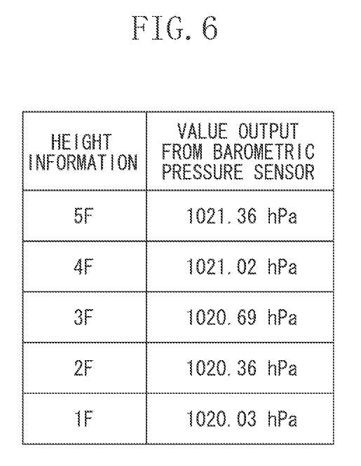

In step S304, the control unit 103 updates the table stored in the memory 104 by using the value obtained in step S303. More specifically, assume that a barometric pressure value of the first floor stored in the table is 1020.00 hPa, whereas a value currently obtained by the barometric pressure sensor 105 is 1020.03 hPa. In such a case, a difference of 0.03 hPa is determined as fluctuation in barometric pressure caused with weather change. In order to correct the difference of 0.03 hPa, the control unit 103 updates the table stored in the memory 104 as illustrated in FIG. 6. More specifically, the barometric pressure value of the first floor is updated from 1020.00 hPa to 1020.03 hPa. The barometric pressure values of the second to the fifth floors are then corrected by adding the difference of 0.03 hPa to the respective values. The elevator does not necessarily have to periodically stop on all of the floors, and the elevator may not stop a floor for a long period of time. The above-described processing can prevent a situation in which a barometric pressure value stored in the table corresponding to such a floor deviates from the actual barometric pressure value due to the weather change. The processing proceeds to step S305.

In the present exemplary embodiment, although it is determined that barometric pressure fluctuates with respect to the difference of 0.03 hPa, this value is merely an example, and the value may be changed as appropriate according to condition. For example, the value may be changed according to a time period that has lapsed since the previous update of the table and/or an amount of difference. In a case where the table is updated frequently, unnecessary processing load can be reduced by increasing the threshold value. The table may be updated using a value corresponding to approximately 10% of the difference instead of using a value of the difference as it is. In such a case, the barometric pressure value approaches an actual value through a plurality of times of updating, which can suppress an effect of noise in the detection processing of the barometric pressure sensor 105. It is desirable that the update processing be repeatedly executed at predetermined intervals, but intervals between the update processes may be increased at night-time or in the case that the elevator is stopped for a long time. Decrease in the update frequency can prevent unnecessary power consumption. Furthermore, vibrations during the moving of the elevator may be directly detected by providing an acceleration rate detection unit and/or a vibration detection unit, and whether or not the elevator stops may be determined based on detection result(s) of the detection unit(s). By using such detection result(s) in combination with the output value of the barometric pressure sensor 105, whether or not the elevator stops can be determined with increased accuracy.

In step S305, the control unit 103 determines whether the elevator is moved. If the control unit 103 determines that the elevator is moved (YES in step S305), the processing returns to step 3302. If the control unit 103 determines that the elevator is not moved (NO in step S305), the processing returns to step S303. Here, the control unit 103 determines whether the elevator is moved based on whether an amount of change in the output values of the barometric pressure sensor 105 is equal to or greater than a predetermined value. For example, if the change amount per one second is 0.10 hPa or more, the control unit 103 determines that the elevator is moved. It is desirable to set, with hysteresis, a threshold value used for determination whether the elevator stops in step S302 and a threshold value used for determination in step S305, as described in the present exemplary embodiment.

As described above, the table can be appropriately corrected through the correction method described with reference to FIG. 5 even if the barometric pressure fluctuates with weather change.

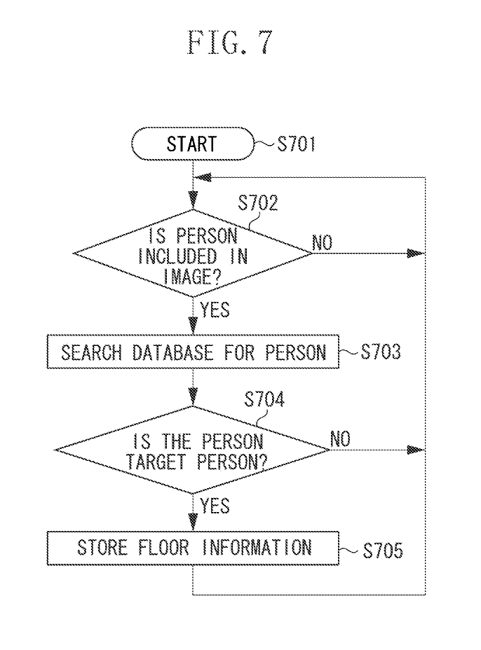

The process for superimposing the information about a current the floor the elevator currently stops (stopping floor) on the image, as described in the present disclosure, is useful in terms of specifying a moving route of a monitoring target person. On the other hand, in the case of the absence of a person in the elevator, the information indicating the stopping floor is not necessary, and thus a useless processing load may be placed on the control unit 103. To that end, the processing illustrated in FIG. 5 may be executed only in a case where the detection unit included in the control unit 103 detects a person in the elevator. In the case of a person being detected, the control unit 103 may add the floor information to the video image and distribute the resultant video image. This process is further desirable because a distribution load can be reduced. Hereinafter, the processing will be described in detail with reference to the flowchart in FIG. 7. The processing is executed by the control unit 103.

In step S701, the control unit 103 starts detection processing. Then, the processing proceeds to step S702.

In step S702, the control unit 103 detects whether a person is included in the image captured by the imaging apparatus 1000 installed inside the elevator. The detection unit included in the control unit 103 executes detection of the person. Then, the processing proceeds to step S703.

In step S703, the control unit 103 searches the database stored in the memory 104 for the person detected in step S702. The database stores features of a target person for the processing of adding the floor information to the image or the metadata. The processing proceeds to step S704. The database does not necessarily have to be stored in the memory 104 but may be stored in a storage device provided on the network 1500.

In step S704, the control unit 103 determines whether the person detected in step S702 is a target person based on a search result obtained in step S703. The control unit 103 can determine whether to add the floor information to the image by comparing the information about the person included in the image with the features registered in the database. If the detected person is the target person (YES in step S704), the processing proceeds to step S705, and if the detected person is not the target person (NO in step s704), the processing returns to step S702.

In step S705, the control unit 103 adds the floor information to the image, which can enable an observer to determine which floor a specific person has gotten on or off the elevator. In the present exemplary embodiment, the control unit 103 corresponds to a person detection unit for detecting a person inside a movable body such as an elevator.

In the present exemplary embodiment, although the processing for appropriately updating the table has been described, the present exemplary embodiment is not limited thereto. A plurality of tables may be previously stored in the memory 104, and a table to be used is switched according to the barometric pressure measured by the barometric pressure sensor 105.

In some cases, the elevator that has not been used for a predetermined time period automatically stops on a floor set as a home. If the home setting is set to the monitoring camera, barometric pressure can be easily associated with the floor number after a condition is satisfied that the elevator automatically stops on the floor set as a home. It is desirable that the home setting be stored in the memory 104.

Hereinafter, a second exemplary embodiment of the present disclosure will be described. Although the exemplary embodiment of the present disclosure has been described with respect to the method for determining whether the elevator stops or is moving, described in steps S302 and S305 in FIG. 5, various modifications are possible in addition to the determination method based on the change amount of the output values of the barometric pressure sensor 105. A description will now be provided of a process for determining whether the elevator stops or is moving based on a video image captured by the imaging apparatus 1000.

A configuration of the imaging apparatus 1000 is similar to that of the first exemplary embodiment. Descriptions will be omitted for other configurations similar to those described in the first exemplary embodiment.

In an example of determining whether the elevator stops or is moving based on the video image, the determination is made based on whether the elevator door is opened or closed when the door is image-captured and appears in a video image. Naturally, the elevator stops when the door is opened. Then, in step S302 or S305, after the control unit 103 determines that the elevator stops based on the output value of the barometric pressure sensor 105, the control unit 103 starts the processing for making a determination for the video image. In a case where the detection unit detects a door being opened from the obtained video image, the control unit 103 can determine that the elevator stops. In the present exemplary embodiment, the control unit 103 corresponds to a door detection unit which detects whether the door unit is opened.

In a case where an indicator provided on the elevator which indicates a current position of the elevator is included in the video image, as to whether the elevator stops or is moving may be determines based on a display state or a lighting state of the indicator, and the table may be updated based on the indicator. The floor number may be determined based on, for example, a floor pattern of the floor when the door is opened. If the light is turned off at night or in the case that the elevator is stopped for a long time, intervals between updates of the table may be changed based on the detection the light off state from the video image. More specifically, the elevator is less likely to be moved while the light is turned off, and thus only the update of the table is executed with the intervals between the updates being increased.

A third exemplary embodiment of the present disclosure will be described below. According to the correction method of the table, described with reference to the flowchart in FIG. 5, the table is constantly updated while the elevator stops. However, the memory 104 may have an upper limit for the number of rewriting times. In such a case, it is desirable that update frequency of the table be reduced. Hereinafter, the process for updating the table according to the present exemplary embodiment will be described with reference to FIG. 7. A configuration of the imaging apparatus 1000 is similar to that of the first exemplary embodiment.

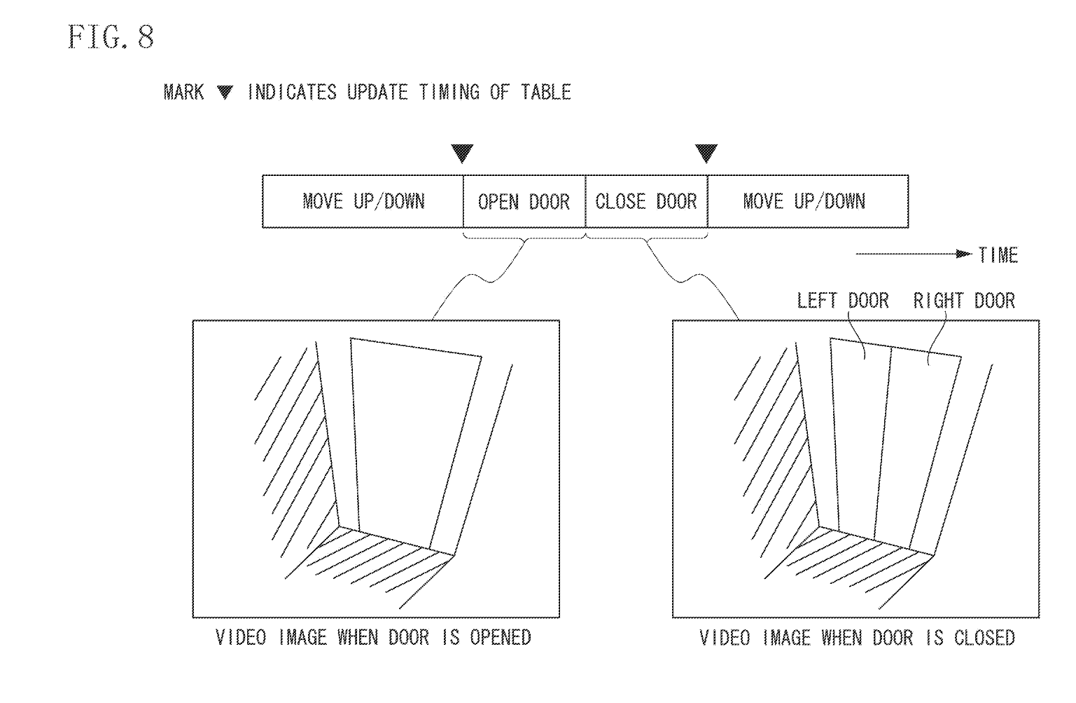

In step S302 or S305, the imaging apparatus 1000 according to the present exemplary embodiment detects whether the door is opened or closed, and updates the table based on the detection result. More specifically, as illustrated in FIG. 8, the control unit 103 updates the table when the door is opened and closed. The update is suspended until the door is closed. Opening and closing of the door are detected by the detection unit.

The method is more desirable because the number of update times of the table can be reduced, so that the number of rewriting times of the memory 104 can be reduced.

In a case where the memory 104 includes a volatile memory unit, such as a dynamic random access memory (DRAM), and a non-volatile memory unit, such as a flash read only memory (ROM), it is desirable that the table be stored in the volatile memory, updated with high frequency, and backed up on the non-volatile memory at predetermined intervals.

In some cases, the table cannot be updated in a case where the power supply is shut off at night for power saving of the elevator itself. In order to deal with such a situation, it is desirable that the non-volatile memory unit of the memory 104 store a floor number on which the elevator stops before the power supply is shut off.

### Exemplary Embodiment Relating to Network Communication

The imaging apparatus 1000 according to the present disclosure is connected to the client apparatus 2000 via the network 1500. The client apparatus 2000 can transmit a control command via the network 1500 so as to control the imaging apparatus 1000 via the network 1500. The imaging apparatus 1000 controls itself based on the received control command and parameters included in the control command. In a case where the imaging apparatus 1000 receives the control command, the imaging apparatus 1000 transmits a response to the received command to the client apparatus 2000. The client apparatus 2000 that receives the response from the imaging apparatus 1000 updates information on the user interface displayed on the display unit provided on the client apparatus 2000 based on the information included in the response.

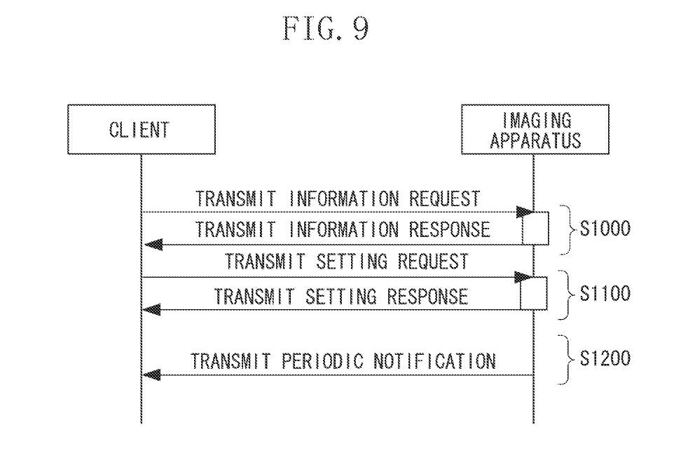

With reference to FIG. 9, a description will now be provided of communication relating to the control command for the imaging apparatus 1000 and the client apparatus 2000. The client apparatus 2000 and the imaging apparatus 1000 communicate with each other through a transaction as a combination of a request and a response.

In transaction S1000, the client apparatus 2000 transmits an information request for obtaining the information stored in the imaging apparatus 1000. The information request can include, for example, a request for inquiring about function information about the imaging apparatus 1000. The function information about the imaging apparatus 1000 includes parameters for compressing and coding the image, an image correction function, and presence or absence of a pan/tilt mechanism. The function information about the imaging apparatus 1000 to be inquired about further includes setting information about a function for adding the floor information.

The imaging apparatus 1000 transmits an information request response as a response to the information request. The information request response includes the functions information about the imaging apparatus 1000 requested by the client apparatus 2000. By using the information, the client apparatus 2000 can recognize the functions of the imaging apparatus 1000.

The client apparatus 2000 can also obtain the state of the imaging apparatus 1000 with the information request. The state of the imaging apparatus 1000 to be obtained includes current control parameters and a position of the pan/tilt mechanism. The state of the imaging apparatus 1000 to be obtained also includes current floor information. With the information, the client apparatus 2000 can recognize the state of the imaging apparatus 1000.

In transaction S1100, the client apparatus 2000 transmits a setting request for setting various parameters in the imaging apparatus 1000. The client apparatus 2000 transmits the setting request based on the functions or the state of the imaging apparatus 1000 previously obtained in transaction S1000. Examples of settable items with the setting request includes, a setting of the parameter for compressing and coding the image, a setting of the image correction function, and an operation of the pan/tilt mechanism.

The imaging apparatus 1000 transmits a setting response as a response to the setting request. The setting response includes information about whether the functions of the imaging apparatus 1000 requested to be set by the client apparatus 2000 have been correctly set. With the information, the client apparatus 2000 can recognize the state of the imaging apparatus 1000.

In transaction S1200, in response to the setting request from the client apparatus 2000, the imaging apparatus 1000 transmits a periodic notification to the client apparatus 2000, which is triggered by a periodic or a predetermined event. The periodic notification includes current floor information as information included in the information request response. With the information, the client apparatus 2000 can recognize the state of the imaging apparatus 1000. More specifically, in a case where a user of the client apparatus 2000 wishes to know a current floor number, the user can obtain information about the current floor number by causing the client apparatus 200 to make an inquiry to the imaging apparatus 1000. The information about the floor number may be described in the metadata relating to the image data distributed by the imaging apparatus 1000.

### Other Exemplary Embodiments

The present disclosure can also be achieved by the process of supplying a program for implementing one or more functions of the above exemplary embodiments to a system or an apparatus via a network or a storage medium, and causing one or more processors of a computer of the system or the apparatus to read and execute the program. The present disclosure can be also realized with a circuit that realizes one or more functions (e.g., application specific integrated circuit (ASIC)).

While the present disclosure has been described in detail with reference to the exemplary embodiments, the present disclosure is not limited to the above-described exemplary embodiments, and many variations and modifications are possible within the scope of the present disclosure. Although description has been given to the exemplary embodiments in which the imaging apparatus 1000 is installed in the elevator, a similar effect can be achieved if the present disclosure is applied to an imaging apparatus that captures an interior image of a movable body of, for example, a vehicle or an aerial tramway.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2016-034829, filed Feb. 25, 2016, which is hereby incorporated by reference herein in its entirety.

What is claimed is:

1. An imaging apparatus that captures an interior image of a movable body comprising:
a barometric pressure detection unit configured to detect barometric pressure inside the movable body;
a storage unit configured to store a table in which a height of a position of the movable body is associated with barometric pressure;
an update unit configured to update the table with a detection result obtained by the barometric pressure detection unit; and
a determination unit configured to determine a moving state of the movable body,
wherein the update unit updates the table based on the determination result of the moving state of the movable body determined by the determination unit.

2. The imaging apparatus according to claim 1,
wherein the moving state includes at least a state in which the movable body stops, and
wherein the determination unit determines whether the movable body stops, based on an amount of change in the detection result obtained by the barometric pressure detection unit.

3. The imaging apparatus according to claim 2, further comprising a door detection unit configured to detect whether a door unit provided to the movable body is opened,
wherein the determination unit determines whether the movable body stops, based on a detection result of the door detection unit.

4. The imaging apparatus according to claim 3, wherein the update unit updates the table based on the detection result of the door detection unit in a case where the door unit is detected to be opened or closed.

5. The imaging apparatus according to claim 1, further comprising:
a judgement unit configured to judge a height of the movable body based on the detection result obtained by the barometric pressure detection unit and the table;
a distribution unit configured to distribute captured video image data about the interior image of the movable body; and
a data control unit configured to associate a judgement result obtained by the judgement unit with the video image data to be distributed by the distribution unit.

6. The imaging apparatus according to claim 5, further comprising a person detection unit configured to detect a person inside the movable body,
wherein the data control unit controls whether to associate the judgement result obtained by the judgement unit with the video image data to be distributed by the distribution unit, based on a detection result obtained by the person detection unit.

7. The imaging apparatus according to claim 5, wherein the data control unit writes the judgement result obtained by the judgement unit into metadata associated with the video image data.

8. The imaging apparatus according to claim 1, further comprising a communication unit configured to communicate with an external apparatus via a network,
wherein the imaging apparatus transmits information about a height of a position of the movable body to an external apparatus using the communication unit.

9. The imaging apparatus according to claim 1, further comprising a receiving unit configured to receive information about external barometric pressure via a network,
wherein the update unit updates the table stored in the storage unit based on the information about the external barometric pressure received by the receiving unit.
